(19) United States
(12) Patent Application Publication
(10) Pub. No.: US 2026/0253962 A1
(43) Pub. Date: Aug. 27, 2026

(54) ELECTROLYTE FOR LITHIUM SECONDARY BATTERY AND LITHIUM SECONDARY BATTERY INCLUDING THE SAME

(71) Applicants: HYUNDAI MOTOR COMPANY, SEOUL (KR); KIA CORPORATION, SEOUL (KR)

(72) Inventors: Dong Hyun Lee, Hwaseong-si (KR); Ji Yong Lee, Hwaseong-si (KR); Won Keun Kim, Hwaseong-si (KR); Eunji Kwon, Hwaseong-si (KR); Samuel Seo, Hwaseong-si (KR); Kyuju Kwak, Hwaseong-si (KR); Jiho Lim, Hwaseong-si (KR); Jeongnam Kim, Hwaseong-si (KR); Sangsu Lee, Hwaseong-si (KR); Kyoung Han Ryu, Hwaseong-si (KR); Yeonjong Oh, Hwaseong-si (KR)

(73) Assignees: HYUNDAI MOTOR COMPANY, SEOUL (KR); KIA CORPORATION, SEOUL (KR)

(21) Appl. No.: 19/340,741

(22) Filed: Sep. 25, 2025

(30) Foreign Application Priority Data
Dec. 13, 2024 (KR) 10-2024-0185580

(51) Int. Cl. H01M 10/0569; B60L 50/60; H01M 10/0525; H01M 10/0567; H01M 10/0568

(52) U.S. Cl. CPC H01M 10/0569; H01M 10/0525; H01M 10/0567; H01M 10/0568; B60L 50/60; H01M 2300/0034; H01M 2300/0037

(57) ABSTRACT

An electrolyte for a lithium secondary battery which includes a lithium salt; a non-aqueous organic solvent including a solvent that weakly binds to the lithium salt and a fluorinated solvent different from the solvent that weakly binds to the lithium salt; and an additive.

### CROSS-REFERENCE TO RELATED APPLICATION

This application claims priority to and the benefit of Korean Patent Application No. 10-2024-0185580 filed with the Korean Intellectual Property Office on Dec. 13, 2024, the entire contents of which are incorporated herein by reference.

### FIELD

The disclosure relates to an electrolyte for a lithium secondary battery and a lithium secondary battery including the same.

### BACKGROUND

As the electric vehicle market grows, there is an increasing need for high-capacity batteries that surpass lithium ion batteries and accordingly, an increasing demand for negative and positive electrode materials with high energy density and high energy density and long-term stability of the lithium metal batteries.

Lithium metal, which has high capacity per weight of 3,860 mAh/g and a low standard electrode potential (−3.04 V vs normal hydrogen electrode), is attracting attention as a negative electrode material for lithium secondary batteries. However, lithium metal is highly reactive, creating an extremely reducing atmosphere during the charging process, which may cause an irreversible decomposition reaction between the lithium metal and an electrolyte. The decomposition reaction may deplete the electrolyte, and the decomposition products may form a non-uniform film on the lithium metal surface. In addition, the lithium typically grows in the form of dendrites, as charging and discharging are repeated. This dendritic lithium causes electrical short circuits inside the batteries, leading to battery safety issues (such as fires and the like).

Therefore, in order to apply lithium metal with high stability and high capacity, there is a need to develop an electrolyte that alleviates reactivity of lithium metal, prevents dendritic lithium growth, and enables uniform lithium electrodeposition (e.g., plating).

### SUMMARY

In an embodiment, the disclosure provides an electrolyte for a lithium metal secondary battery capable of achieving improved performance (e.g., durability) and can suppress a decrease in ionic conductivity at temperatures that range from ambient and below.

In an embodiment the disclosure provides a lithium secondary battery including the electrolyte in accordance with the disclosure.

In some embodiments, an electrolyte for a lithium secondary battery according to an embodiment includes: a lithium salt; a non-aqueous organic solvent comprising a solvent that weakly binds to the lithium salt, and a fluorinated solvent different from the non-aqueous organic solvent; and an additive. In some embodiments, the solvent that weakly binds to the lithium salt comprises, or is selected from at least one of, dipropylether, diethylether, 1,2-diethoxyethane, cyclopentylmethylether, methylpropylether, n-butylmethylether, ethylpropylether, dimethoxymethane, 1,4-dioxane, 1,2,2-tetrafluoroethyl-2,2,3,3-tetrafluoropropylether, ethyl acetate, ethyl 3,3,3-trifluoropropanoate, fluoroethylene carbonate, ethylmethylsulfone, 1,3-propanesulfone, tetramethylenesulfone, (1-(trifluoromethyl)sulfonyl)piperidine, and/or a combination thereof; and the additive comprises, or is selected from at least one of, fluoroethylene carbonate, lithium difluoro (oxalato) borate, lithium difluorobis(oxalato)phosphate, lithium difluorophosphate, lithium nitrate, vinylene carbonate, and/or a combination thereof.

In some embodiments, the solvent that weakly binds to the lithium salt may be included in an amount of 38 volume % to 75 volume % based on a total volume of the electrolyte.

In some embodiments, the fluorinated solvent may be included in an amount of 25 volume % to 62 volume % based on the total volume of the electrolyte.

In some embodiments, ta molar ratio of the lithium salt and the solvent that weakly binds to the lithium salt may be 1:1.5 to 1:2, respectively.

In some embodiments, a molar ratio of the lithium salt, the solvent that weakly binds to the lithium salt, and the fluorinated solvent may be 1:2:1.5, respectively.

In some embodiments, the lithium salt may include at least one of Lithium bis(fluorosulfonyl)imide (LiFSI), Lithium bis(trifluoromethanesulfonyl)imide (LiTFSI), Lithium hexafluorophosphate (LiPF₆), Lithium perchlorate (LiClO₄), Lithium tetrafluoroborate (LiBF₄), Lithium trifluoromethanesulfonate (LiSO₃CF₃), Lithium bis(oxalato) borate (LiBOB), Lithium difluoro (oxalato) borate (LiFOB), Lithium difluorobis(phenyl)phosphate (LiDFBP), Lithium trifluoro (oxalato)phosphate (LiTFOP), Lithium difluorophosphate (LiPO₂F₂), Lithium chloride (LiCl), Lithium bromide (LiBr), Lithium iodide (LiI), Lithium decachlorodecaborate (LiB₁₀Cl₁₀), Lithium trifluoromethanesulfonate (LiCF₃SO₃), Lithium trifluoroacetate (LiCF₃CO₂), Lithium hexafluoroarsenate (LiAsF₆), Lithium hexafluoroantimonate (LiSbF₆), Lithium tetrachloroaluminate (LiAlCl₄), Lithium methanesulfonate (CH₃SO₃Li), Lithium trifluoromethanesulfonate (CF₃SO₃Li), Lithium thiocyanate (LiSCN), or Lithium tris(trifluoromethanesulfonyl) methide (LiC(CF₃SO₂)₃).

In some embodiments, the molar concentration of the lithium salt may be 1 M to 3 M.

In some embodiments, the additive may include lithium difluorophosphate, lithium nitrate, and vinylene carbonate. In some further embodiments, the lithium difluorophosphate may be included in a weight amount less than the lithium nitrate, and the lithium nitrate may be included in a weight amount less than the vinylene carbonate.

In some embodiments, the additive may be included in an amount of 1 wt % to 5 wt % based on a total weight of the electrolyte.

In some embodiments, the fluorinated solvent comprises, or is selected from at least one of, 1,1,2,2-tetrafluoroethyl-2,2,3,3-tetrafluoropropylether, 1,1,2,2-tetrafluoroethyl-1,1,5-octafluoropentylether, and/or a combination thereof.

In another aspect, the disclosure provides a lithium secondary battery that comprises a positive electrode, a negative electrode current collector facing the positive electrode, a separator between the positive electrode and the negative electrode current collector, and the electrolyte for the lithium secondary battery in accordance with the aspects and embodiments of the disclosure.

In some embodiments, a lithium metal layer formed on the negative electrode current collector may be included. In further embodiments, the lithium metal layer may be formed by the chemical charging and discharging of the lithium secondary battery.

In some embodiments, the positive electrode may include a positive electrode active material layer including a lithium-nickel-manganese-cobalt-based metal oxide or a lithium iron phosphate-based metal oxide.

In some embodiments, the electrolyte for a lithium secondary battery can improve the cycle-life performance of a lithium secondary battery even at temperatures below ambient temperatures such as, for example, at a lower temperature of −15° C. or lower.

### BRIEF DESCRIPTION OF THE DRAWINGS

FIG. 1 schematically illustrates the reactions when the interaction (bonding) between the solvent and lithium salt in the electrolyte is strong and weak at room temperature and low temperature, respectively.

FIGS. 2A and 2B show the results of measuring lithium reversibility according to the molar ratio between a lithium salt and a solvent that weakly binds to the lithium salt, depending on the rate.

FIG. 3 shows the results of measuring lithium reversibility according to the molar ratio among the lithium salt, the solvent that weakly binds to the lithium salt, and the fluorinated solvent different from the solvent that weakly binds to the lithium salt (Li salt:weak binding solvent:fluorinated solvent).

FIGS. 4A and 4B show the results of evaluating the lithium reversibility and cycle-life performance of battery cells using the electrolytes of Example 1 and Comparative Example 1.

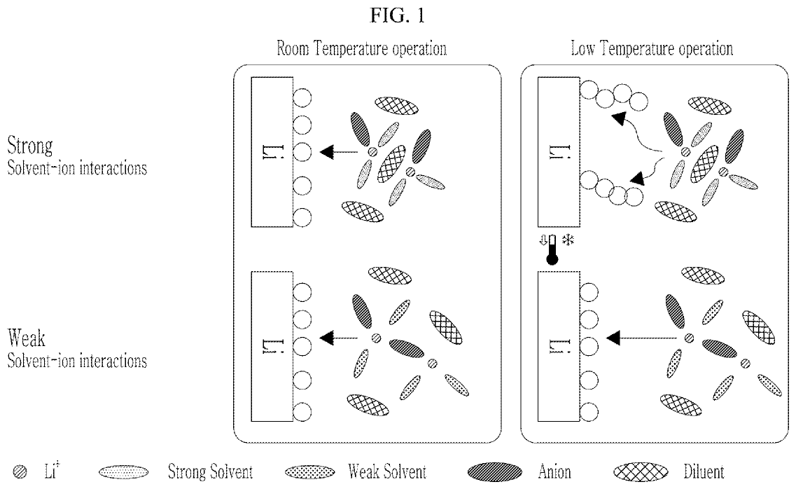

### DETAILED DESCRIPTION

The specification includes terms, (e.g., including first, second, and third) that are used for describing various arts, components, regions, layers, and/or sections, but are not limited thereto. The terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present embodiment.

Any special terminology used herein is for the purpose of describing specific exemplary embodiments only and is not intended to be limiting of the present embodiment. The singular forms used herein include plural forms as well, if the phrases do not clearly have the opposite meaning. The term “including” or “comprising” used in the specification means that a specific feature, region, integer, step, operation, element and/or component is embodied and other specific features, regions, integers, steps, operations, elements, and/or components are not excluded.

When any part of one or more element(s) are referred to as being “on”, “over”, “above”, etc., another part or portion of an element, the terms can include arrangement of parts or elements which might be directly on or over the other parts or may include a different part therebetween the two or more identified part. Conversely, when any part is mentioned as being “directly on” (or “over”, “above”, etc.) the other part(s), there are no other part(s) interposed therebetween the identified parts.

Unless defined otherwise, all terms including technical and scientific terms used herein have the same meaning as commonly understood by those skilled in the art to which the present embodiment belongs. Commonly used predefined terms are further interpreted as having a meaning consistent with the relevant technical literature and the present disclosure and are not to be construed as having any limited or particular meanings unless defined otherwise.

As used herein, the term “combination(s) thereof” when included in the various alternative embodiments described herein (e.g., as “Markush” groups, or as lists that “comprise” one or more elements) refers to one or more mixtures or combinations selected from the components described as members of the embodiments, and refers to at least one of the recited components.

The detailed description that follows provides further description of the various aspects and embodiments in accordance with the disclosure, including some illustrative and exemplary embodiments. Those skilled in the art will appreciate that the described embodiments may be modified in various different ways without departing from the spirit or scope of the general disclosure.

### <Electrolyte for Lithium Secondary Battery>

An electrolyte for a lithium secondary battery according to an embodiment of the disclosure, may include a lithium salt; a non-aqueous organic solvent including a solvent that weakly binds to the lithium salt and a fluorinated solvent different from the solvent that weakly binds to the lithium salt; and an additive.

In some general applications, an organic electrolyte for use in a lithium metal battery can comprise an ether-based organic solvent; however, because such an organic solvent typically has low oxidation stability, a strategy has been implemented to generate high-concentration conditions by adding excess amounts of salt. An alternative attempted solution intended to improve the resulting increase in viscosity and decrease in ionic conductivity comprises addition of a fluorine-based viscosity-reducing agent as a cosolvent. While this approach can suppress side reactions between lithium metal and electrolyte through its use of a high-concentration lithium salt without the typical high viscosity and low ionic conductivity (each of which are disadvantages of a high-concentration electrolyte) through the introduction of a fluorinated solvent, a shortcoming of the approach is that the limits to the ratio/amount of the fluorinated solvent that may be added is too low. Another methodology for adding a fluorinated solvent in an excessive amount has been attempted, in an attempt to improve durability performance while maintaining the ionic conductivity at conventional level; however, this solution was only in narrow temperature ranges (i.e., at room temperature), and did not achieve the same performance under low temperature conditions.

Since battery characteristics must be evaluated in consideration of their use in a variety of different environmental conditions, there remains a need for an electrolyte that can exhibit the same properties and durability of conventional electrolytes, e.g., at room temperature, while further exhibiting improved discharge capacity at non-ambient temperatures (e.g., below-zero temperature), relative to conventional electrolyte performance. The disclosure addresses this, and other needs in the art, by providing an electrolyte composition having improved low-temperature characteristics. In some embodiments, the disclosure provides an ether-based superlocal high-concentration electrolyte that can improve low-temperature characteristics of a lithium metal battery comprising the electrolyte. In embodiments, the electrolyte comprises a solvent that exhibits reduced bonding affinity between Li ions and the solvent (weak bonding), when compared to conventional electrolyte solvents.

As mentioned above, prior attempts to add an excess amount of a fluorinated solvent to an ether-based electrolyte having a high-concentration lithium salt, exhibit a critical problem in that a strong bonding between lithium ions and the solvent makes low temperature performance difficult or even inoperative.

Accordingly, the inventors have developed an electrolyte comprising a solvent that weakly binds to a lithium salt, rather than a solvent that strongly binds to the lithium salt, that improves the low temperature discharge characteristics of a lithium ion battery.

In accordance with an aspect, the disclosure provides an electrolyte for a lithium secondary battery comprising: a lithium salt; a non-aqueous organic solvent comprising a solvent that weakly binds to the lithium salt and a fluorinated solvent that different from the non-aqueous organic solvent; and an additive.

In some embodiments of the disclosure, the solvent that weakly binds to the lithium salt may be one or more of dipropylether, diethylether, 1,2-diethoxyethane, cyclopentylmethylether, methylpropylether, n-butylmethylether, ethylpropylether, dimethoxymethane, 1,4-dioxane, 1,2,2-tetrafluoroethyl-2,2,3,3-tetrafluoropropylether, ethyl acetate, ethyl 3,3,3-trifluoropropanoate, fluoroethylene carbonate, ethylmethylsulfone, 1,3-propanesulfone, tetramethylenesulfone, (1-(trifluoromethyl)sulfonyl)piperidine, and/or a combination thereof.

In some embodiments, the solvent that weakly binds to the lithium salt may be included in an amount of 38 volume % to 75 volume %, inclusive, for example, of such ranges as 40 volume % to 75 volume %, and/or 50 volume % to 60 volume % based on a total volume of the electrolyte, and inclusive of any value falling within those recited ranges. In embodiments wherein the solvent that weakly binds to the lithium salt falls within the above volume range, the solvent allows for the salt to be dissolved while at the same time containing a level (i.e., an amount/concentration) of salt that enables battery operation.

In accordance with some embodiments of the disclosure, the fluorinated solvent is different in type from the solvent that weakly binds to the lithium salt and, in some non-limiting embodiments may be, for example, 1,1,2,2-tetrafluoroethyl-2,2,3,3-tetrafluoropropyl ether, 1,1,2,2-tetrafluoroethyl-1,1,5-octafluoropentyl ether, and/or a combination thereof.

In some embodiments, the fluorinated solvent may be included in an amount of 25 volume % to 62 volume %, inclusive, for example, of such ranges as 25 volume % to 60 volume %, and/or 40 volume % to 50 volume % based on a total volume of the electrolyte. In embodiments wherein the fluorinated solvent falls within the above volume ranges, the fluorinated solvent allows for the battery to be easily operated even at relatively low temperatures (e.g., zero ° C. and below).

In some embodiments, the molar ratio of the lithium salt and the solvent that weakly binds to the lithium salt may be from 1:1 to 1:2, including, for example, 1:1.5 to 1:2. In embodiments wherein the molar ratio of the lithium salt and the solvent that weakly binds to the lithium salt falls within the ranges described above, lithium reversibility may be improved, such that the battery cycle-life performance may be significantly increased.

In some embodiments, the molar ratio of the lithium salt, the solvent that weakly binds to the lithium salt, and the fluorinated solvent may be 1:2:1.5. Without limitation to any mechanism, it has been observed that as the ratio of the lithium salt increases, that is, as the ratio of the solvent that weakly binds to the lithium salt decreases, the lithium reversibility improves, which can significantly increase the battery cycle-life performance. In contrast, however, it has been observed that as the ratio of the fluorinated solvent (i.e., co-solvent) increases, a battery can exhibit greater instability. As such, embodiments that maintain control of the molar ratio of the lithium salt, the solvent that weakly binds to the lithium salt, and the fluorinated solvent as described above may be particularly preferred in terms of improving the battery stability and/or the battery cycle-life performance.

In some embodiments, the additive may include one or more of fluoroethylene carbonate, lithium difluoro (oxalato) borate, lithium difluorobis(oxalato)phosphate, lithium difluorophosphate, lithium nitrate, and/or vinylene carbonate, and/or a combination thereof.

In some further embodiments, the additive may include lithium difluorophosphate, lithium nitrate and vinylene carbonate, wherein the lithium difluorophosphate may be included in a weight amount that is less than the lithium nitrate, and the lithium nitrate may be included in a weight amount that is less than the vinylene carbonate. In embodiments wherein the additive types and weight relationships are maintained within those described above, an SEI layer may be stably formed on the negative and positive electrode surfaces, even at a high rate, which enables the manufacture of a lithium metal secondary battery with improved cycle-life characteristics and high efficiency.

In some embodiments, the additive may be included in an amount of 1 wt % to 5 wt %, and inclusive of ranges and amounts within that range such as, for example, 2 wt % to 3 wt % based on a total weight of the electrolyte. One of skill will appreciate, however, that the amount of the additive is not limited to those specific amounts and can be included in any range that is sufficient to maintain the desired and favorable characteristics of a lithium metal secondary battery, as disclosed herein.

According to an embodiment, the lithium salt may include at least one of Lithium bis(fluorosulfonyl)imide (LiFSI), Lithium bis(trifluoromethanesulfonyl)imide (LiTFSI), Lithium hexafluorophosphate (LiPF₆), Lithium perchlorate (LiClO₄), Lithium tetrafluoroborate (LiBF₄), Lithium trifluoromethanesulfonate (LiSO₃CF₃), Lithium bis(oxalato) borate (LiBOB), Lithium difluoro (oxalato) borate (LiFOB), Lithium difluorobis(phenyl)phosphate (LiDFBP), Lithium trifluoro (oxalato)phosphate (LiTFOP), Lithium difluorophosphate (LiPO₂F₂), Lithium chloride (LiCl), Lithium bromide (LiBr), Lithium iodide (LiI), Lithium decachlorodecaborate (LiB₁₀Cl₁₀), Lithium trifluoromethanesulfonate (LiCF₃SO₃), Lithium trifluoroacetate (LiCF₃CO₂), Lithium hexafluoroarsenate (LiAsF₆), Lithium hexafluoroantimonate (LiSbF₆), Lithium tetrachloroaluminate (LiAlCl₄), Lithium methanesulfonate (CH₃SO₃Li), Lithium trifluoromethanesulfonate (CF₃SO₃Li), Lithium thiocyanate (LiSCN), or Lithium tris(trifluoromethanesulfonyl) methide (LiC(CF₃SO₂)₃). In some embodiments, the lithium salt may be LiFSI.

In some embodiments, a concentration of the lithium salt included in the electrolyte for a lithium secondary battery may be from 1.0 to 3.0 M and can specifically include such ranges as, for example, 1.5 M to 2.5 M, 1.6 M to 2.4 M, 1.7 M to 2.3 M, 1.8 M to 2.2 M, or 1.9 M to 2.1 M.

In embodiments wherein the concentration of the lithium salt is below the above range, the conductivity of the electrolyte may decrease, which may result in poor electrolyte performance. Furthermore, in embodiments wherein the concentration of the lithium salt exceeds the above range, the viscosity of the electrolyte may increase, which may result in reduced mobility of lithium ions and create a problematic overvoltage that can occur from the beginning of the cycle. Additionally, undesirable lithium salt concentrations can create a thick film that is formed on the surface of the negative electrode current collector or the negative electrode, which may deteriorate the electrochemical performance of the lithium secondary battery.

### <Lithium Secondary Battery>

In another aspect, the disclosure provides a lithium secondary battery including the electrolyte for a lithium secondary battery in accordance with the aspects and embodiments described herein.

In some embodiments, the lithium secondary battery may include a positive electrode, a current collector facing the positive electrode, a separator between the positive electrode and the negative electrode current collector, and the electrolyte for a lithium secondary battery in accordance with the disclosure.

In some embodiments, the negative electrode current collector for a lithium secondary battery itself may be used as a negative electrode for a battery.

In some embodiments, the negative electrode for a battery or the negative electrode current collector for a battery does not separately include any lithium insertion material or any lithium metal, and may be assembled with the positive electrode, the separator, and other components into an electrode assembly, and a battery. As described below, in a battery including the negative electrode for a battery (or the negative electrode current collector for a battery), lithium ions may move from the positive electrode to the negative electrode during the charge to form a lithium metal layer. Such a battery may be charged and discharged by formation or removal of the lithium metal layer.

In some embodiments, the lithium metal layer may be formed on the negative electrode current collector by formation charge and discharge of the lithium secondary battery.

In another embodiment, the positive electrode is disposed opposite the negative electrode current collector for the battery.

In some embodiments, the positive electrode may include a positive electrode current collector and a positive electrode active material layer formed on the positive electrode current collector.

In some embodiments, the positive electrode collector may be made of stainless steel, aluminum, nickel, titanium, calcined carbon, or aluminum or stainless steel surface-treated with carbon, nickel, titanium, silver, and the like.

In some embodiments, the thickness of the positive electrode collector may be 3 μm to 500 μm.

In some embodiments, the positive electrode active material layer includes a positive electrode active material.

In some embodiments, the positive electrode active material may include a lithium metal oxide that is capable of intercalating and deintercalating lithium. In some embodiments, the lithium metal oxide can comprise at least one of cobalt, manganese, nickel, and aluminum. In further embodiments, the lithium metal oxide may include at least one of a lithium-manganese-based oxide, a lithium-cobalt-based oxide, a lithium-nickel-based oxide, a lithium-nickel-manganese-based oxide, a lithium-nickel-cobalt-based oxide, a lithium-manganese-cobalt-based oxide, a lithium-nickel-manganese-cobalt-based oxide, a lithium-manganese-cobalt-based oxide, and/or a lithium-nickel-cobalt-transition metal (M) oxide.

In some embodiments, the positive electrode active material may be a lithium-nickel-manganese-cobalt-based oxide that may improve the capacity characteristics and stability of the battery. In some further embodiments, the lithium-nickel-manganese-cobalt-based oxide may be Li(Ni_{0.6}Mn_{0.2}Co_{0.2})O₂, Li(Ni_{0.5}Mn_{0.3}Co_{0.2})O₂, and/or Li(Ni_{0.8}Mn_{0.1}Co_{0.1})O₂.

In some embodiments, the positive electrode active material may be a lithium iron phosphate-based oxide that can improve the capacity characteristics and/or stability of the battery.

In some embodiments, the positive electrode active material layer may further include a binder and/or a conductive material.

Suitably, the separator separates (i.e., physically) the negative electrode and the positive electrode and provides a passage (e.g., flow path) for lithium ions to move. The separator in accordance with the disclosure is not particularly limited and can comprise any separator that finds use in lithium secondary batteries.

The following examples are provided merely for the purpose of further detail and illustration of some selected embodiments of the disclosure. It will be appreciated that the following examples only illustrate some embodiments, and are not limiting to the full scope of the disclosure and appended claims.

### (Example) Preparation of Electrolyte for Lithium Secondary Battery

To prepare a series of example electrolytes in accordance with the disclosure, an amount of LiFSI salt is added to a solvent that weakly binds to a lithium salt (hereinafter, a solvent) to form a solution (Table 1). To the solution, amounts of LiPO₂F₂, LiNO₃, and VC are added, in order, and mixed to form a transparent solution. Subsequently, a fluorinated solvent (hereinafter, a cosolvent) is added to the solution, and mixed until transparent (Table 1). The solution is examined for any solid precipitate.

Table 1 summarizes the components and amounts thereof that were used to generate the illustrative electrolyte compositions according to examples and comparative examples, as shown.

TABLE 1

| | Salt | | Solvent | | Cosolvent | | Additive | |
|---|---|---|---|---|---|---|---|---|
| | | Material | | Material | | Material | | Material |
| | Amount | name | Amount | name | Amount | name | Amount | name |
| Ex. 1 | 1 mole | LiFSI | 2 moles | DEE | 1.5 moles | TTE | 0.3 wt % | LiPO₂F₂ |
| | (2M) | | (55 vol %) | | (45 vol %) | | 0.5 wt % | LiNO₃ |
| | | | | | | | 2 wt % | VC |

| | | | | | | | |
|---|---|---|---|---|---|---|---|
| Ex. 2 | 1 mole | LiFSI | 1 mole | DEE | 1.5 moles | TTE | same as Ex. 1 |
| | (2.7M) | | (38 vol %) | | (62 vol %) | | |
| Ex. 3 | 1 mole | LiFSI | 5 moles | DEE | 1.5 moles | TTE | same as E. 1 |
| | (1.1M) | | (75 vol %) | | (25 vol %) | | |
| Comp. | 1 mole | LiFSI | 2 moles | DME | 1.5 moles | TTE | same as Ex. 1 |
| Ex. 1 | (1.7M) | | (48 vol %) | | (52 vol %) | | |

Abbreviations used
LiFSI: Lithium Bis(fluorosolfonyl)imide
DEE: 1,2-diethoxyethane
DME: 1,2-dimethoxyethane
TTE: 1,1,2,2-Tetrafluoroethyl 2,2,3,3-Tetrafluoropropyl Ether
LiPO₂F₂: Lithium difluorophosphate
LiNO₃: Lithium nitrate
VC: Vinylene carbonate

### Evaluation Example 1: Simulation of Intermolecular Bond Strength when Solvent is Changed

The bond strength between lithium ions and anions/solvent in each of the electrolytes is difficult to measure experimentally. Thus, a simulation was used to measure intermolecular bond strength, with the results shown in Table 2.

The simulation indicates that Comparative Example 1 exhibited relatively stronger bonding between Li-solvent than between Li-FSI, confirming relatively strong interaction (e.g., strong solvation). In contrast, Example 1 exhibited relatively stronger bonding between Li-FSI than between Li-solvent, confirming relatively weak interaction (e.g., weak solvation).

TABLE 2

| | Binding Energy (eV) | | |
|---|---|---|---|
| Solvent | Li-FSI | Li-solvent | solvent-FSI |
| Comparative | −1.4374 | −1.5328 | −0.203 |
| Example 1 | | | |
| (DME) | | | |
| Example 1 | −2.0015 | −1.7509 | −0.2137 |
| (DEE) | | | |

### Evaluation Example 2: Simulation of Change in Intermolecular Distance According to Concentration when Solvent is Changed

It is difficult to measure bond strength between lithium ions and anions/solvent in each of the electrolytes, experimentally. Thus, a simulation was used to measure the bond strength indirectly by measuring each intermolecular distance. Tables 3 and 4 summarize the density of molecules present in a solvation shell for each salt:solvent ratio as measured.

The data in Tables 3 and 4, indicate that a relatively weaker bond strength between lithium ion/solvent, is associated with farther distance between lithium ion/solvent, and closer distance between anion/solvent. Example 1, having a solvent (DEE) with weak bond strength, exhibited a lower density of anions and solvent in the solvation shell when compared to Comparative Example 1, having a solvent (DME) with stronger bond strength. The simulation also confirmed that as the amount of the solvent increased relative to the amount of salt, the density of the anion decreased, and the density of the solvent increased.

TABLE 3

| Compo- | | | | | |
|---|---|---|---|---|---|
| sition | N_{Li} | N_{N}_{_{FSI}} | No_{DME} | ρ N_{FSI}[Å⁻³] | ρ N_{DME}[Å⁻³] |
| 1:1 | 350 | 350 | 700 | 0.002984 | 0.005969 |
| 1:3 | 150 | 150 | 900 | 0.001467 | 0.008805 |
| 1:5 | 100 | 100 | 1000 | 0.000941 | 0.009405 |

TABLE 4

| Compo- | | | | | |
|---|---|---|---|---|---|
| sition | N_{Li} | N_{N}_{_{FSI}} | No_{DDE} | ρ N_{FSI}[Å⁻³] | ρ N_{DDE}[Å⁻³] |
| 1:1 | 300 | 300 | 600 | 0.002541 | 0.005082 |
| 1:3 | 120 | 120 | 720 | 0.001249 | 0.006852 |
| 1:5 | 80 | 80 | 800 | 0.000723 | 0.007226 |

### Evaluation Example 3: Durability Evaluation of Cu-NCM Coin Cell by Salt/Solvent Ratio

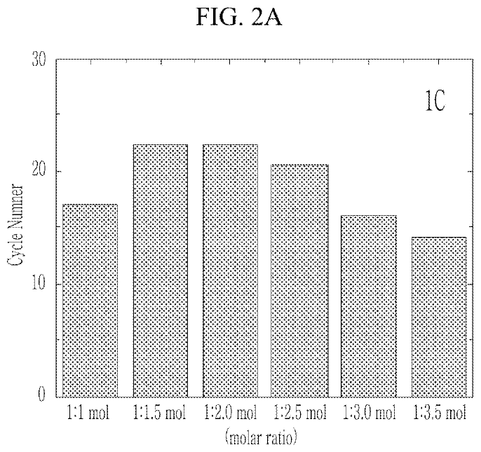

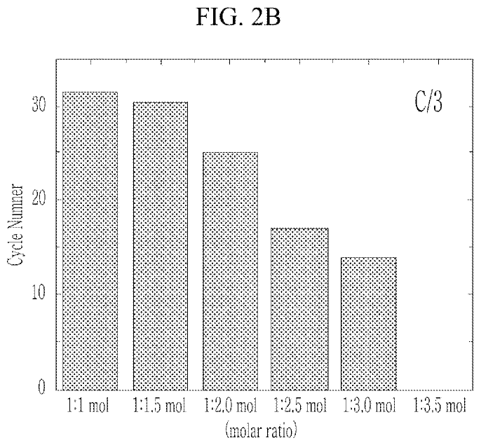

A Cu-NCM cell was evaluated at each salt:solvent ratio and each rate to measure lithium reversibility, which can help to further improve or optimize the solvent composition. The results are shown in FIGS. 2A and 2B.

The data indicates that at a C/3 rate, the higher concentration provides for a larger lithium reversibility, but at a 1 C rate, lithium reversibility was higher at the salt:solvent ratios of 1:1.5 and 1:2. The data indicates that the best cycle-life performance may be achieved in a composition with a salt:solvent ratio at, or about, 1:2.

### Evaluation Example 4: Durability Evaluation of Cu-NCM Coin Cell by Cosolvent Ratio

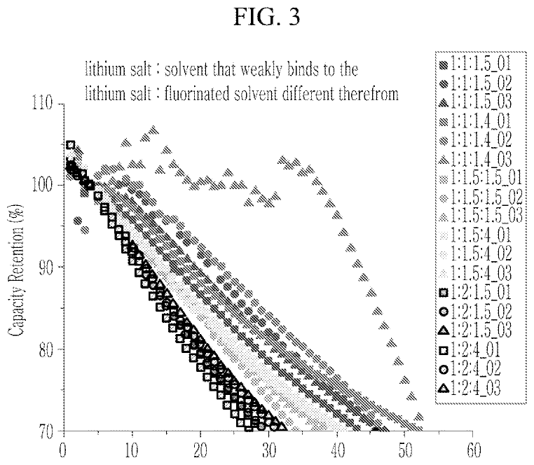

A perfluorinated high-concentration electrolyte is prepared to evaluate durability by adding a fluorinated cosolvent at various ratios of salt:solvent:cosolvent, with each ratio performed in triplicate. The results are shown in FIG. 3 and can be used to predict lithium reversibility.

Referring to FIG. 3, the data indicates that at higher salt ratios (or at lower solvent was ratios), there was a greater improvement in cycle-life performance. The data also indicates that as the solvent became more fluorinated (at higher cosolvent ratios), an increase in instability characteristics was observed. The experiment validated that, for various embodiments and compositions, it is possible to determine a content of cosolvent in the composition at an appropriate level (i.e., workable level), and even at relatively optimal levels. The data illustrated here indicates the best durability performance can be achieved with a composition having a molar ratio of lithium salt, the solvent that weakly binds to the lithium salt, and the fluorinated solvent to be at, or about, 1:2:1.5 (salt:solvent:cosolvent).

### Evaluation Example 5: Evaluation of Cu-LFP Bi-Cell Cycle-Life Performance

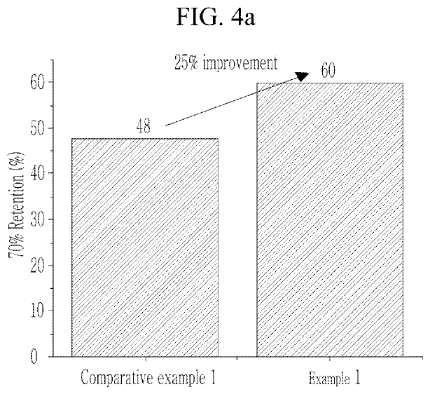

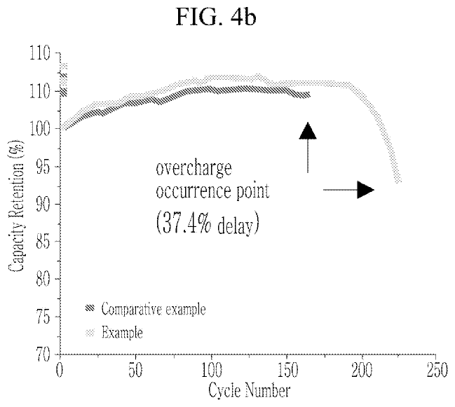

Lithium reversibility (Cu) and cycle-life performance (Li) were evaluated using an LFP-based positive electrode, with the results shown in FIGS. 4A and 4B. The lithium reversibility was predicted in FIG. 4A, and the actual durability performance was measured in FIG. 4B.

Referring to FIGS. 4A and 4B, the LFP-based positive electrode exhibits 25% durability improvement, which indicates that a weak bonding force between salt and solvent was effective for LFP. In the actual Li-LFP pouch bi-cell evaluation durability results (FIG. 4B), Example 1 exhibited a delayed overcharge occurrence point, compared to Comparative Example 1 (37.4% delay).

### Evaluation Example 6: Evaluation of Low-Temperature Discharge Characteristics

Low temperature discharge characteristics were measured for the various Examples and Comparative Example to assess the effect of solvent/salt binding strength, with the results shown in Table 5. Table 2 shows a ratio of discharge capacity at each temperature based on 100% discharge at room temperature.

TABLE 5

Discharge Capacity (%)

| | | | | |
|---|---|---|---|---|
| | Comparative | | | |
| Temp. | Example1 | Example 1 | Example 2 | Example 3 |

| | |
|---|---|
| (° C.) | Bi-cell |

| | | | | |
|---|---|---|---|---|
| 25 | 100% | 100% | 100% | 100% |
| −10 | 74% | 77.5% | 70.2% | 84.9% |
| −15 | 54.1% | 67.4% | 2.5% | 82.2% |
| −20 | 14% | 41.5% | 1% | 70.2% |

Referring to Table 5, there was no large difference between the comparative example and the examples at −10° C.; however, a sharp difference was observed at temperatures of −15° C. or below, with the example including the solvent that weakly binds to the salt exhibiting excellent low temperature discharge characteristics. In Example 2, an explanation as to why the low-temperature characteristics markedly deteriorated may be that as the distance between anion and cation of the salt becomes smaller (shorter) at a high salt concentration, bonding force between salt and solvent became insignificant. Conversely, at an extremely low temperature (−20° C.), Example 1 exhibited three times better low-temperature discharge characteristics than Comparative Example 1, and Example 3 exhibited almost five times better low-temperature discharge characteristics than Comparative Example 1, suggesting that it may be desirable to include a solvent that exhibits weak binding to a salt.

### Evaluation Example 7: Discharge Rate Evaluation at −10° C.

Low temperature discharge rate was measured for Example 1 and Comparative Example 1 compositions to evaluate operation under various conditions, with the results shown in Table 6. Table 6 shows a ratio of discharge capacity at different rates based on ⅓ C.

TABLE 6

discharge capacity
(relative to ⅓ C)

| Cell No. | 0.1 C | ⅓ C | 0.5 C | ⅔ C |
|---|---|---|---|---|
| Comparative | 115.3% | 100.0% | 54.1% | 5.2% |
| Example 1 | | | | |
| Example 1 | 109.9% | 100.0% | 82.0% | 39.8% |

As the low-temperature results show, Example 1 (vs. Comparative Example 1) exhibited the faster C-rate, and the better discharge capacity, which indicates that discharge capacity can be increased by reducing/weakening bonding force between salt and solvent even at a high rate.

While a number of illustrative embodiments of the present disclosure have been described above, the disclosure and appended claims (and equivalents) are not limited to these embodiments. One of skill will be able to envision and make various modifications that fall within the scope of the patent claims, the detailed description, and the attached drawings.

What is claimed is:

1. An electrolyte for a lithium metal secondary battery, comprising
a lithium salt;
a non-aqueous organic solvent including: a solvent that weakly binds to the lithium salt, and a fluorinated solvent different therefrom; and
an additive;
wherein the solvent that weakly binds to the lithium salt is selected from dipropylether, diethylether, 1,2-diethoxyethane, cyclopentylmethylether, methylpropylether, n-butylmethylether, ethylpropylether, dimethoxymethane, 1,4-dioxane, 1,2,2-tetrafluoroethyl-2,2,3,3-tetrafluoropropylether, ethyl acetate, ethyl 3,3,3-trifluoropropanoate, fluoroethylene carbonate, ethylmethylsulfone, 1,3-propanesulfone, tetramethylenesulfone, (1-(trifluoromethyl)sulfonyl)piperidine, and a combination thereof, and
the additive comprises fluoroethylene carbonate, lithium difluoro (oxalato) borate, lithium difluorobis(oxalato)phosphate, lithium difluorophosphate, lithium nitrate, vinylene carbonate, or a combination thereof.

2. The electrolyte of claim 1, wherein
the solvent that weakly binds to the lithium salt is included in an amount of 38 volume % to 75 volume % based on a total volume of the electrolyte.

3. The electrolyte of claim 1, wherein
the fluorinated solvent is included in an amount of 25 volume % to 62 volume % based on the total volume of the electrolyte.

4. The electrolyte of claim 1, wherein
a molar ratio of the lithium salt and the solvent that weakly binds to the lithium salt is in a range of 1:1.5 to 1:2.

5. The electrolyte of claim 1, wherein
a molar ratio of the lithium salt, the solvent that weakly binds to the lithium salt, and the fluorinated solvent is 1:2:1.5.

6. The electrolyte of claim 1, wherein
the lithium salt comprises at least one selected from Lithium bis(fluorosulfonyl)imide (LiFSI), Lithium bis(trifluoromethanesulfonyl)imide (LiTFSI), Lithium hexafluorophosphate (LiPF₆), Lithium perchlorate (LiClO₄), Lithium tetrafluoroborate (LiBF₄), Lithium trifluoromethanesulfonate (LiSO₃CF₃), Lithium bis(oxalato) borate (LiBOB), Lithium difluoro (oxalato) borate (LiFOB), Lithium difluorobis(phenyl)phosphate (LiDFBP), Lithium trifluoro (oxalato)phosphate (LiTFOP), Lithium difluorophosphate (LiPO₂F₂), Lithium chloride (LiCl), Lithium bromide (LiBr), Lithium iodide (LiI), Lithium decachlorodecaborate (LiB₁₀Cl₁₀), Lithium trifluoromethanesulfonate (LiCF₃SO₃), Lithium trifluoroacetate (LiCF₃CO₂), Lithium hexafluoroarsenate (LiAsF₆), Lithium hexafluoroantimonate (LiSbF₆), Lithium tetrachloroaluminate (LiAlCl₄), Lithium methanesulfonate (CH₃SO₃Li), Lithium trifluoromethanesulfonate (CF₃SO₃Li), Lithium thiocyanate (LiSCN), or Lithium tris(trifluoromethanesulfonyl) methide (LiC(CF₃SO₂)₃).

7. The electrolyte of claim 1, wherein
a molar concentration of the lithium salt is in a range of 1 M to 3 M.

8. The electrolyte of claim 1, wherein
the additive comprises lithium difluorophosphate, lithium nitrate, and vinylene carbonate, and wherein
the lithium difluorophosphate is included in a weight amount less than the weight amount of lithium nitrate, and
the lithium nitrate is included in a weight amount less than the weight amount of vinylene carbonate.

9. The electrolyte of claim 8, wherein
the additive is included in an amount of 1 wt % to 5 wt % based on a total weight of the electrolyte.

10. The electrolyte of claim 1, wherein
the fluorinated solvent is selected from 1,1,2,2-tetrafluoroethyl-2,2,3,3-tetrafluoropropylether, 1,1,2,2-tetrafluoroethyl-1,1,5-octafluoropentylether, and a combination thereof.

11. A lithium secondary battery, comprising
a positive electrode;
a negative electrode current collector facing the positive electrode;
a separator between the positive electrode and the negative electrode current collector; and
the electrolyte for a lithium secondary battery of claim 1.

12. The lithium secondary battery of claim 11, wherein
the negative electrode current collector comprises a lithium metal layer, and wherein
the lithium metal layer is formed by charging and discharging of the lithium secondary battery.

13. The lithium secondary battery of claim 11, wherein
the positive electrode comprises a positive electrode active material layer comprising a lithium-nickel-manganese-cobalt-based metal oxide or a lithium iron phosphate-based metal oxide.
